(19) United States
(12) Patent Application Publication
(10) Pub. No.: US 2010/0192224 A1
(43) Pub. Date: Jul. 29, 2010

(54) SANDBOX WEB NAVIGATION

(75) Inventors: Luca Ferri, Rome (IT); Luigi Pichetti, Rome (IT); Marco Secchi, Rome (IT); Antonio Secomandi, Brugherio (IT)

Correspondence Address: IBM AUSTIN IPLAW (DG), C/O DELIZIO GILLIAM, PLLC, 15201 MASON ROAD, SUITE 1000-312, CYPRESS, TX, 77433, US

(73) Assignee: International Business Machines Corporation, Armonk, NY (US)

(21) Appl. No.: 12/359,457

(22) Filed: Jan. 26, 2009

(51) Int. Cl. G06F 3/048; G06F 21/00

(52) U.S. Cl. 726/23; 715/760

(57) ABSTRACT

Browsing the World Wide Web may expose a user's system to malicious attacks that can lead to data loss and/or system failure. Sometimes a user desires to access information on a web page that may contain malicious content. For example, a college student researching computer hacking may need information provided on a hacking website even though the site is potentially dangerous. Although techniques are employed to install potentially harmful executable files into a sandbox (e.g., virtual machine), these techniques do not address navigation of harmful sites. Functionality can be implemented to instantiate a web browser within a controlled virtual environment (“sandbox”) that simulates the host system while restricting the virtual environment to designated space(s) and/or resources of the host system to prevent harmful effects. Instantiating the web browser in the sandbox allows web navigation of risky web sites without deleterious effects on the host system.

### BACKGROUND

Embodiments of the inventive subject matter generally relate to the field of computers, and, more particularly, to sandbox web navigation.

The World Wide Web is an extraordinary system for accessing and sharing information, content, programs, images, video, music, etc. However, web browsing is subject to the risk of malicious attacks that may be embedded in innocent looking content and web pages. Malicious content varies from well known computer viruses, worms, dialers to dangerous spy-ware. Malicious attacks attempt to alter the targeted system with the execution of dangerous programs and/or modify or change the configuration of existing programs or system functions.

### SUMMARY

Embodiments include a method directed to detecting selection of a hyperlink in a host session of a host system. It is determined that a web page referenced by the hyperlink should be opened in a sandbox session. The sandbox session virtualizes at least some resources of the host system. The sandbox session is created. A web browser is opened in the sandbox session. The web page referenced by the hyperlink is loaded in the web browser in the sandbox session.

### BRIEF DESCRIPTION OF THE DRAWINGS

The present embodiments may be better understood, and numerous objects, features, and advantages made apparent to those skilled in the art by referencing the accompanying drawings.

FIG. 1 depicts an example conceptual diagram of opening a hyperlink in a sandbox session.

FIG. 2 is a flowchart depicting example operations for opening a hyperlink in a sandbox session.

FIG. 3 is a flowchart depicting example operations for saving an artifact in a sandbox session.

FIG. 4 depicts an example computer system.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. For instance, although examples refer to browsers, embodiments may be implemented in other applications such as email applications. In other instances, well-known instruction instances, protocols, structures and techniques have not been shown in detail in order not to obfuscate the description.

Browsing the World Wide Web may expose a user's system to malicious attacks that can lead to data loss and/or system failure. Sometimes a user desires to access information on a web page that may contain malicious content. For example, a college student researching computer hacking may need information provided on a hacking website even though the site is potentially dangerous. Although techniques are employed to install potentially harmful executable files into a sandbox (e.g., virtual machine), these techniques do not address navigation of harmful sites. Functionality can be implemented to instantiate a web browser within a controlled virtual environment (“sandbox”) that simulates the host system while restricting the virtual environment to designated space(s) and/or resources of the host system to prevent harmful effects. Instantiating the web browser in the sandbox allows web navigation of risky web sites without deleterious effects on the host system.

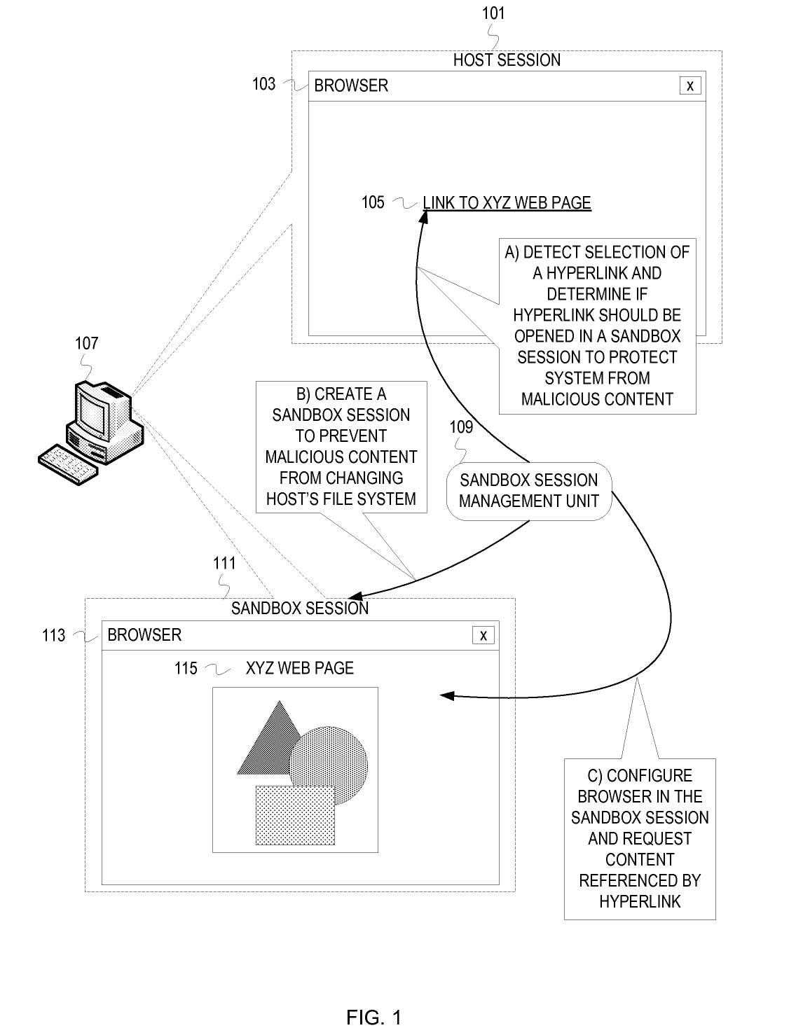

FIG. 1 depicts an example conceptual diagram of opening a hyperlink in a sandbox session. A host session 101 is running on a host 107. The host session 101 may directly access and alter execution space and/or resources of the host 107. A browser 103 is running in the host session 101.

At stage A, a sandbox session management unit 109 detects selection of a hyperlink 105 and determines that a web page XYZ referenced by the hyperlink 105 should be opened in a sandbox session 111. Examples of detecting selection of a hyperlink include detecting a click on a hyperlink in a web page, typing a Uniform Resource Locator (URL) into an address bar, choosing a hyperlink from a list of favorites, etc. In some embodiments, determining that the hyperlink should be opened in a sandbox session is based on manual user indication. For example, a user suspects that a hyperlink contains malicious content. The user chooses an option from a right-click menu to open the hyperlink in a sandbox session. In other embodiments, determining that the hyperlink should be opened in a sandbox session is automatic based on a set of policies. Policies may be defined by a user or an administrator, or may be default settings. Policies regarding domain names, origin countries, file extensions, etc. can be used to determine if the web page referenced by the hyperlink is potentially unsafe and should be opened in a sandbox session.

At stage B, the sandbox session management unit 109 creates a sandbox session 111 to prevent possible malicious content from changing the host's memory space and/or resources not allocated to the sandbox session. Examples of malicious content include viruses, worms, spy-ware, dialers, etc. For example, the sandbox session 111 may be implemented as a virtual machine on the host 107. The virtual machine simulates the host 107 to prevent alteration of the real host 107. When the sandbox session 111 is closed, changes made in the sandbox session do not persist in the host, although a user can configure the sandbox session to allow certain changes to persist.

At stage C, the sandbox session management unit 109 instantiates a browser 113, assuming the browser 113 was not already instantiated, and configures the browser 113 in the sandbox session 111. The sandbox session management unit 109 also requests the content referenced by the hyperlink 105. When the requested content is received, the browser 113 renders a web page 115. The sandbox session management unit 109 may or may not have configured the browser 113 with the same configuration settings as the browser 103 in the host session 101. In some cases, a browser in a sandbox session may be configured with additional security settings. Examples of additional security settings include disabling opening of additional hyperlinks, disabling running of scripts, etc. In some embodiments, tokens created in a host session may not be passed to a sandbox session. For example, a user logs into a website in the host session and a security token is created. The user clicks on a hyperlink in the host session which causes a sandbox session to instantiate a browser and the browser to open the web page referenced by the hyperlink, but the security token is not passed from the host session 101 to the sandbox session 111. The user is prompted to login to the website again in the sandbox session 111. In other embodiments, tokens created in the host session may be passed to the sandbox session. For example, a tracking cookie is created in the host session when a user navigates to a web page. When the user attempts to download a file, a web page referenced by the hyperlink to the file is opened in a sandbox session. The tracking cookie is passed from the host session to the sandbox session when the sandbox session is created.

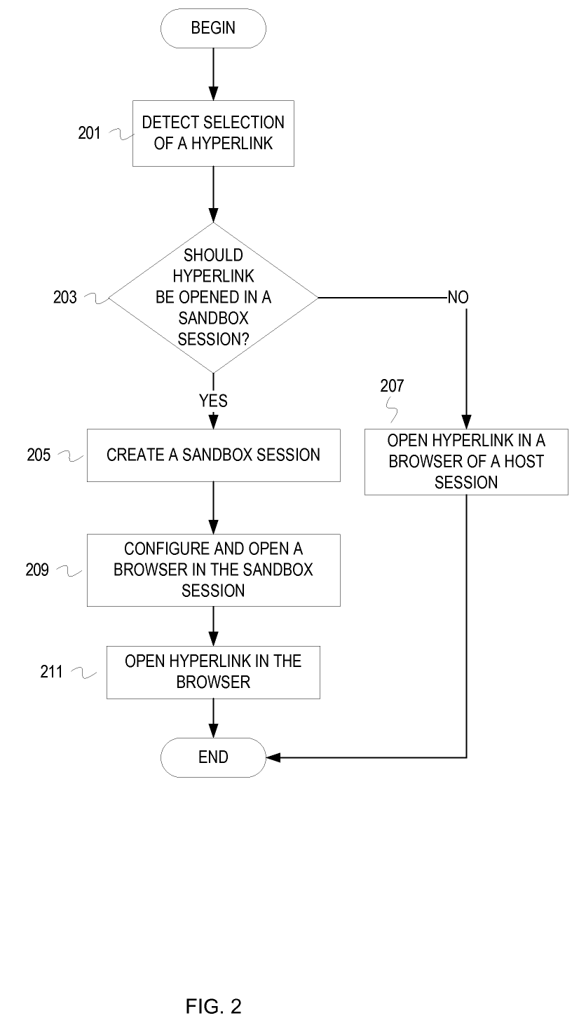

FIG. 2 is a flowchart depicting example operations for opening content referenced by a hyperlink in a sandbox session. Flow begins at block 201 where selection of a hyperlink is detected. For example, a user clicks a hyperlink in a Portable Document Format (PDF) file existing on the user's hard drive.

At block 203, it is determined if content referenced by the hyperlink should be opened in a sandbox session. Determining if the content should be opened in a sandbox session may be manual based on user interaction or automatic based on a set of policies. If the content should be opened in a sandbox session, flow continues at block 205. If the content should not be opened in a sandbox session, flow continues at block 207.

At block 205, a sandbox session is created. The sandbox session is configured so that no states or files persist beyond termination of the sandbox session. For example, all temporary internet files are removed when the sandbox session completes. In addition, the sandbox session may be configured with firewall and/or antivirus protection. For example, a firewall in a sandbox session may be configured to block network activity not related to a browser.

At block 209, a browser is opened and configured in the sandbox session. For example, the browser may be configured the same as a browser running in a host session where the hyperlink was selected. As another example, the browser may be configured to limit navigation to the selected hyperlink or hyperlinks within the same domain as the selected hyperlink.

At block 211, the content is opened in the browser of the sandbox session. Opening content comprises requesting the content referenced by the hyperlink from a source (e.g., web server), and rendering the content returned from the source in the browser. The sandbox session isolates any potential malicious content returned from the source from space and/or resources not allocated to the sandbox session.

At block 207, the content is opened in a browser of a host session.

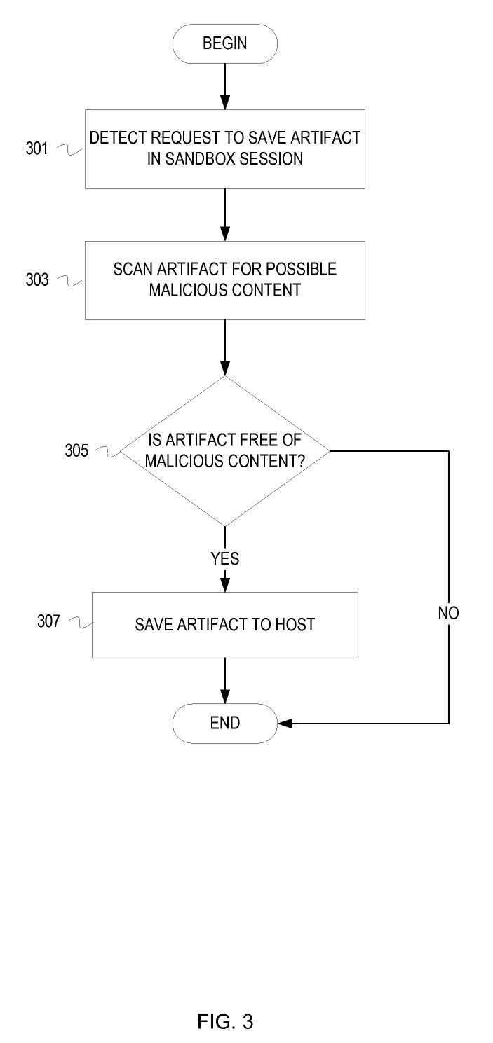

A sandbox session protects a host by preventing content from being stored on the host beyond the confines of the sandbox session. In some cases, a user may desire to save an artifact contained within the content referenced by a hyperlink opened in the sandbox session. Examples of artifacts include PDF files, images, word processing documents, spreadsheets, etc. FIG. 3 is a flowchart depicting example operations for saving an artifact to persist beyond a sandbox session. Flow begins at block 301, where a request to save an artifact in a sandbox session is detected. Examples of detecting a request to save an artifact include detecting a click on a save option in a drop down or right-click menu, a click on a save button on a toolbar, etc.

At block 303, the artifact is scanned for possible malicious content. The sandbox session initiates at least one of an antivirus scan, a spy-ware scan and a mal-ware scan on the artifact. Note that the entire content of the hyperlink is not scanned, just the desired artifact. The antivirus, spy-ware and mal-ware applications may be running in either the sandbox session or a host session. If the applications are running in the sandbox session, the scan(s) are invoked on the artifact by the sandbox session. If the applications are running in the host session, the sandbox session passes the artifact (e.g., places the artifact in a shared folder) to the host session with a request to run the scan(s). The host session then scans the artifact.

At block 305, it is determined if the artifact is free of malicious content. If the artifact is free of malicious content, flow continues at block 307. If the artifact is not free of malicious content, flow ends.

At block 307, the artifact is saved to persist beyond the sandbox session. In this embodiment, artifacts are saved if they are determined to be free of malicious content. In other embodiments, an attempt to remove malicious content from an artifact may be made when malicious content is found in the artifact. If the malicious content is removed from the artifact, the artifact is saved to the host.

In some embodiments, browser plug-ins allow content referenced by hyperlinks to be opened in a sandbox session and artifacts in the sandbox session to be saved to a host. A first browser plug-in in the host session determines that a content referenced by a selected hyperlink should be opened in a sandbox session. The first plug-in may determine that the content referenced by the hyperlink should be opened in a sandbox session by manual interaction with a user. For example, an option in a right-click menu allows the user to indicate a desire to open the hyperlink in a sandbox session. The first plug-in may determine that the hyperlink should be opened in a sandbox session automatically based on one or more policies. For example, hyperlinks to domains that do not belong to a company's domain should be opened in a sandbox session. A virtual machine image is configured to disallow access to external networks and modifications that persist. When the virtual machine is started, virtualization application programming interfaces (APIs) are utilized to invoke, control and terminate the browser in the sandbox session. For example, if a virtual machine is implemented by virtualization software provided by VMWare™, the first plug-in can leverage VIX APIs to locate and start the virtual machine, login to the operating system, open the web browser, and load content referenced by the hyperlink. A second browser plug-in in the sandbox session allows an artifact to be saved to a host. For example, a user selects a spreadsheet file that is part of the content referenced by the hyperlink and chooses a “Save As” option from a drop down menu. The second browser plug-in determines that the file should be saved to the host and utilizes APIs to scan the file for malicious content and save the file to the host if malicious content is not found.

Techniques for opening content referenced by hyperlinks in a browser of a sandbox session can be extended to opening email attachments in email applications. Potentially dangerous attachments may be opened in a sandbox session to allow a user to view the content of an attachment without harming the host. Viewing the content of the attachment in a sandbox session allows the user to avoid waiting for antivirus, spy-ware and/or mal-ware scans to complete. After viewing the content, the user may decide to save the attachment, and then performing appropriate antivirus, spy-ware and mal-ware scans on the attachment.

It should be understood that the depicted flowcharts are examples meant to aid in understanding embodiments and should not be used to limit embodiments or limit scope of the claims. Embodiments may perform additional operations, fewer operations, operations in a different order, operations in parallel, and some operations differently. For instance, referring to FIG. 2, the operations for configuring a browser in the sandbox session and opening the hyperlink in the browser may be combined.

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

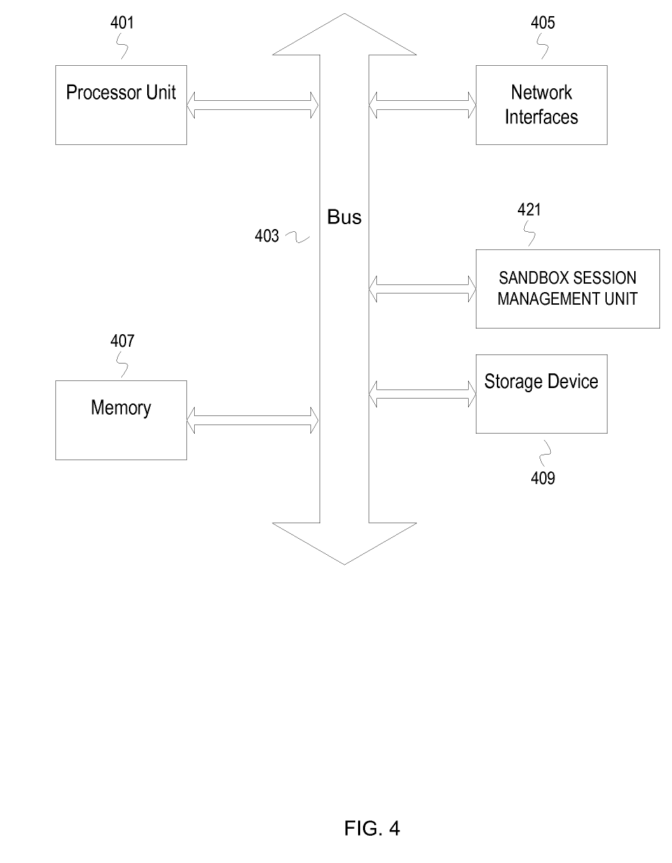

FIG. 4 depicts an example computer system. A computer system includes a processor unit 401 (possibly including multiple processors, multiple cores, multiple nodes, and/or implementing multi-threading, etc.). The computer system includes memory 407. The memory 407 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 403 (e.g., PCI, ISA, PCI-Express, HyperTransport®, InfiniBand®, NuBus, etc.), a network interface 405 (e.g., an ATM interface, an Ethernet interface, a Frame Relay interface, SONET interface, wireless interface, etc.), and a storage device(s) 409 (e.g., optical storage, magnetic storage, etc.). The computer system also includes a sandbox session management unit 421 that activates potentially malicious hyperlinks in a sandbox environment to protect a host from being changed by malicious content. Any one of these functionalities may be partially (or entirely) implemented in hardware and/or on the processing unit 401. For example, the functionality may be implemented with an application specific integrated circuit, in logic implemented in the processing unit 401, in a co-processor on a peripheral device or card, etc. Further, realizations may include fewer or additional components not illustrated in FIG. 4 (e.g., video cards, audio cards, additional network interfaces, peripheral devices, etc.). The processor unit 401, the storage device(s) 409, and the network interface 405 are coupled to the bus 403. Although illustrated as being coupled to the bus 403, the memory 407 may be coupled to the processor unit 401.

While the embodiments are described with reference to various implementations and exploitations, it will be understood that these embodiments are illustrative and that the scope of the inventive subject matter is not limited to them. In general, techniques for opening hyperlinks in a sandbox environment as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
detecting selection of a hyperlink in a host session of a host system;
determining that a web page referenced by the hyperlink should be opened in a sandbox session, wherein the sandbox session virtualizes at least some resources of the host system;
creating the sandbox session;
opening a web browser in the sandbox session; and
loading the web page referenced by the hyperlink in the web browser in the sandbox session.

2. The method of claim 1, wherein said determining that the web page should be opened in the sandbox session is based on one of manual user indication and automatic determination based on a set of policies.

3. The method of claim 1 further comprising isolating the host from potential malicious content in the hyperlink.

4. The method of claim 3 further comprising preventing content from being stored on the host.

5. The method of claim 1 further comprising saving an artifact of the web page to persist beyond the sandbox session.

6. The method of claim 5 further comprising determining if the artifact contains malicious content.

7. The method of claim 6 further comprising running one or more of an antivirus scan, a spy-ware scan and a mal-ware scan on the artifact.

8. The method of claim 1, wherein said creating the sandbox session further comprising instantiating a virtual machine with a browser plug-in of a web browser in the host session.

9. A method comprising:
determining that a web page referenced by a hyperlink should be opened in a sandbox session, wherein the sandbox session virtualizes resources of a host system;
loading the web page in a web browser in the sandbox session;
detecting a request to save an artifact of the web page;
determining that the artifact is free of malicious content; and
saving the artifact to persist beyond termination of the sandbox session.

10. The method of claim 9, wherein said determining that the artifact is free of malicious content further comprises running one or more of an antivirus scan, a spy-ware scan and a mal-ware scan on the artifact.

11. The method of claim 10 further comprising attempting to remove malicious content from an artifact if the artifact is determined to contain malicious content.

12. The method of claim 10, wherein said detecting the request to save the artifact comprises detecting a request to save the artifact by a browser plug-in of the web browser in the sandbox session.

13. The method of claim 12 further comprising utilizing virtualization application programming interfaces to determine that the artifact is free of malicious content and to save the artifact to persist beyond termination of the sandbox session.

14. One or more machine-readable media having stored therein a program product, which when executed by a set of one or more processor units causes the set of one or more processor units to perform operations that comprise:
detecting selection of a hyperlink in a host session of a host system;
determining that a web page referenced by the hyperlink should be opened in a sandbox session, wherein the sandbox session virtualizes at least some resources of the host system;
creating the sandbox session;
opening a web browser in the sandbox session; and
loading the web page referenced by the hyperlink in the web browser in the sandbox session.

15. The machine-readable media of claim 14, wherein said operation of determining that the web page should be opened in the sandbox session is based on one of manual user indication and automatic determination based on a set of policies.

16. The machine-readable media of claim 14, wherein said operations further comprise isolating the host from potential malicious content in the hyperlink.

17. The machine-readable media of claim 16, wherein the operations further comprise preventing content from being stored on the host.

18. The machine-readable media of claim 14, wherein the operations further comprise saving an artifact of the web page to persist beyond the sandbox session.

19. The machine-readable media of claim 18, wherein the operations further comprise determining if the artifact contains malicious content.

20. The machine-readable media of claim 19, wherein the operations further comprise running one or more of an antivirus scan, a spy-ware scan and a mal-ware scan on the artifact.

21. The machine-readable media of claim 14, wherein said operation of creating the sandbox session further comprises instantiating a virtual machine with a browser plug-in.

22. An apparatus comprising:
a set of one or more processing units;
a network interface; and
a sandbox session management unit operable to,
detect selection of a hyperlink in a host session of a host system;
determine that a web page referenced by the hyperlink should be opened in a sandbox session, wherein the sandbox session virtualizes at least some resources of the host system;
create the sandbox session;
open a web browser in the sandbox session; and
load the web page referenced by the hyperlink in the web browser in the sandbox session.

23. The apparatus of claim 22 further comprising one or more machine-readable media that embody the sandbox session management unit.
